(19) United States
(12) Patent Application Publication
(10) Pub. No.: US 2018/0012528 A1
(43) Pub. Date: Jan. 11, 2018

(54) Centrally Controlled and Scheduled Automatic Flagpole

(71) Applicants: Erik Merle Mortensen, Shakopee, MN (US); Trent Ronald Miller, Shakopee, MN (US)

(72) Inventors: Erik Merle Mortensen, Shakopee, MN (US); Trent Ronald Miller, Shakopee, MN (US)

(21) Appl. No.: 15/205,785

(22) Filed: Jul. 8, 2016

(51) Int. Cl. G09F 17/00; E04H 12/32

(52) U.S. Cl. CPC G09F 17/00; E04H 12/32; G09F 2017/0025

(57) ABSTRACT

The Centrally Controlled and Scheduled Automatic Flagpole System offers a fully compliant raising and lowering of flags at dawn, dusk and inclement weather as well as automatically positioning flags at half and full mast as deemed by state, federal or territory laws or executive order. When flags are not able to be flown; the flag will store within the storage box. Those questioning why flag is or is not at half-mast will be informed by a beacon or email distribution list.

### GENERAL FIELD

By removing the need to manually raise, lower or put a flag in half mast position a property owner or manager can be assured their flags are flying at the proper position at all times.

### BACKGROUND & CIRCUMSTANCES

Currently property owners and/or managers must be aware what position their flag should be flying and must manually manage flag positions. By automating full flag flying compliance to US Code Title 4 Chapter 1 §6, 7, & 8 property owners and/or managers can be certain of compliance, reduce labor cost associated to manually adjusting flag position and avoid public scrutiny or questioning on whether or not they are compliant.

Component Overview:

There are three primary components to the Centrally Controlled and Scheduled Automatic Flagpole System:

Component 1:

Central Hub:
The Central Hub is a software platform that communicates to both of the other system components. The Central Hub contains the following data elements with its database:
   1. US Code Title 4 Chapter 1 § 6, 7, & 8 which dictate how and when flags should be raised at either full or half mast
   2. U.S. State and Territory guidelines for how and when flags should be raised at either full or half-mast.
   3. U.S. Time Zone Data by zip code
   4. U.S. Sunrise and Sunset Times by day of the year and zip code
   5. Current flag position for each individual flagpole utilizing the Centrally Controlled and Scheduled Automatic Flagpole System.
   6. Ages of each flag being controlled by the Centrally Controlled and Scheduled Automatic Flagpole System.
   7. Dates when new flags are due to be shipped to properties utilizing the Centrally Controlled and Scheduled Automatic Flagpole System.
   8. Contact information for properties utilizing the Centrally Controlled and Scheduled Automatic Flagpole System.
   9. End-User scheduled changes to flag positioning
   10. Current Weather conditions for each property utilizing the Centrally Controlled and Scheduled Automatic Flagpole System.
   11. Reasoning for each change in flag position for properties utilizing the Centrally Controlled and Scheduled Automatic Flagpole System.
   12. Short description explaining why each flag position change occurs
   13. Client financial & payment data for automated billing purposes
   14. Individual application characteristics
      a. Flagpole height
      b. Flag Type
      c. Flag Size
      d. Flag Illuminated (yes or no)
The Central Hub also enables or contains the following functionality:
   1. Full compliance to US Code Title 4 Chapter 1 §6, 7, & 8
   2. Pushing alerts to clients making them aware of changes in flag positioning and why the change occurred.
   3. Override capability to manually change flag position from Central Hub
   4. Automatically ordering and shipping new flags to clients
   5. Automatically processing client payments on predetermined billing cycles.
   6. Allow end-users to override Central Hub

Component 2:

Controller Box:
The Controller Box is affixed to the flagpole and both sends and receives information to control the position of the flag. Additionally the Controller Box allows for manual control of the flag position for on-site personnel. Methods of communication the Controller Box utilizes vary on the application. Those include but are not limited to:
   1. Bluetooth
   2. Wireless
   3. Cellular
   4. Beacon
   5. Android / Apple Communication Systems
   6. Or Any Future Means of Electronic Communication

Component 3:

Customer Interface:
The Client Interface is how each individual client will be empowered to interact with the Centrally Controlled and Scheduled Automatic Flagpole System. This interface will allow clients to perform the following functions:
   1. Manage their contact information
   2. Manage their alerts
   3. Override the Central Hub
   4. Submit new or updated billing information
   5. Update firmware
   6. Setup Automatic replacement flag purchases
   7. Change individual flagpole characteristics

### DESCRIPTION OF DRAWINGS

FIG. 1 Illustration Shows Central Hub electronically communicating to the Controller Box which then positions Flag to Full Mast

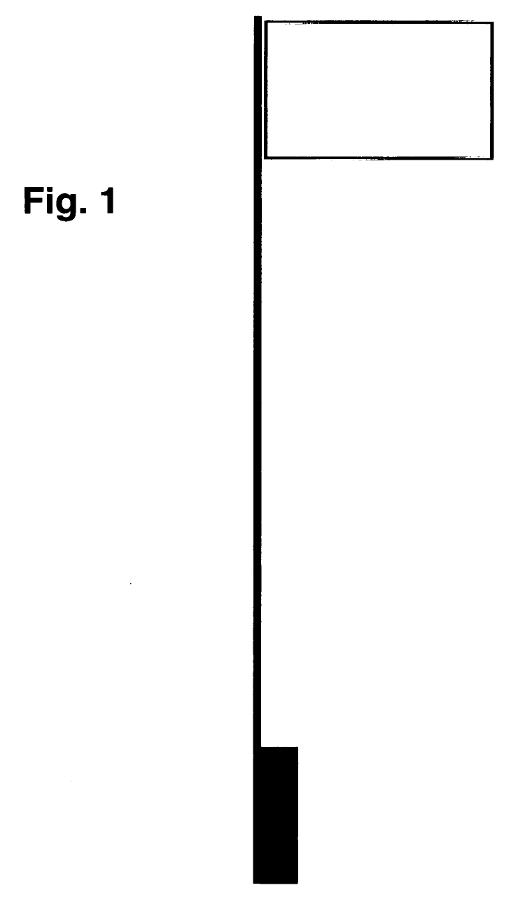

FIG. 2 Illustration Shows Central Hub electronically communicating to the Controller Box which then positions Flag at Half Mast

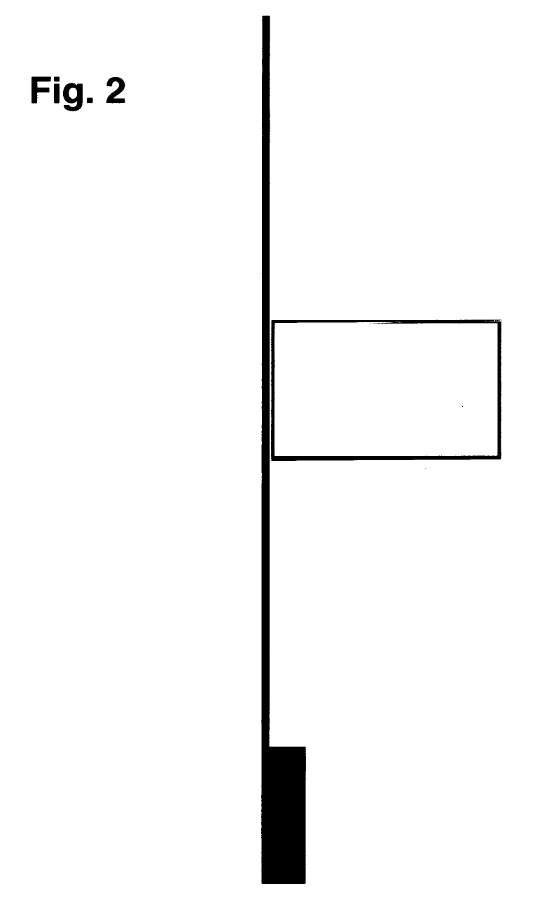

FIG. 3 Illustration Shows Central Hub electronically communicating to the Controller Box which then positions/stores Flag inside Controller Box

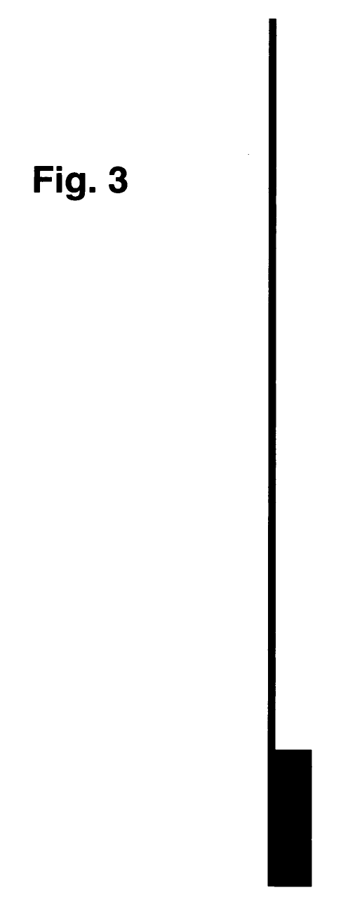

FIG. 4 Illustration Shows The Three Components of the Process and the Two Way Communication between Controller Box, Central Hub and Customer Interface.

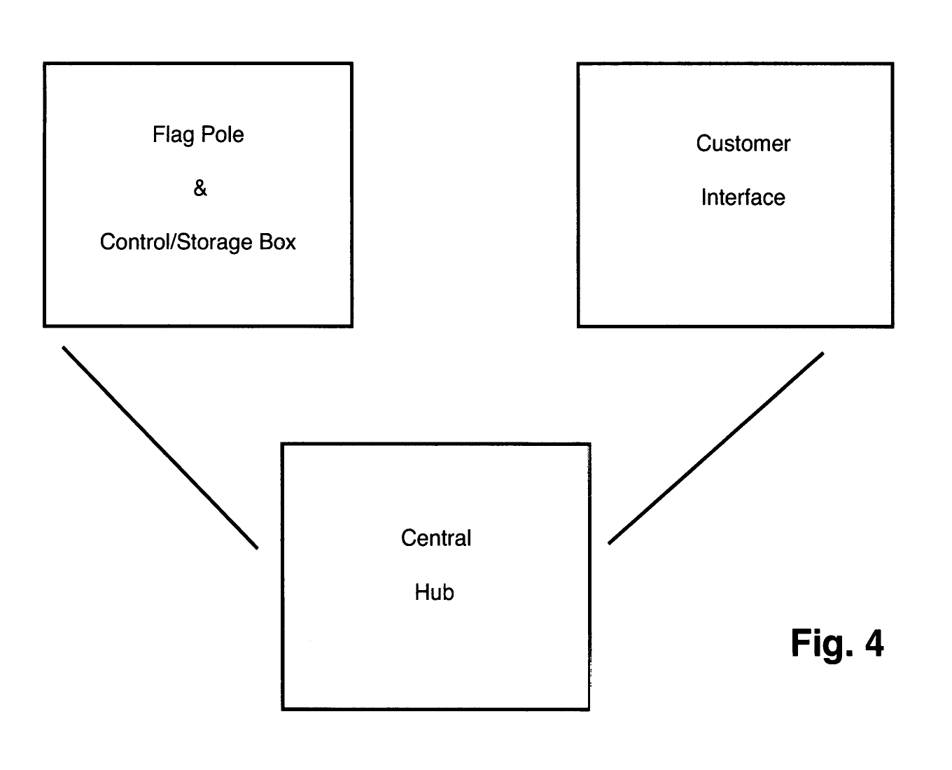

1. Fully automated U.S. flag positioning in accordance with Title 4, Chapter 1 §6, 7, & 8
